(19) United States
(12) Patent Application Publication
(10) Pub. No.: US 2019/0064349 A1
(43) Pub. Date: Feb. 28, 2019

(54) ULTRASONIC PROBE AND PHOTOACOUSTIC APPARATUS INCLUDING SAME

(71) Applicant: CANON KABUSHIKI KAISHA, Tokyo (JP)

(72) Inventor: Koichi Suzuki, Kodaira-shi (JP)

(21) Appl. No.: 16/111,061

(22) Filed: Aug. 23, 2018

(30) Foreign Application Priority Data
Aug. 30, 2017 (JP) 2017-165128

(51) Int. Cl. G01S 15/89; G01S 7/52

(52) U.S. Cl. CPC G01S 15/8965; G01S 7/52077

(57) ABSTRACT

An ultrasonic probe includes a light source that irradiates a subject with emitted light, an acoustic wave reception unit that receives an acoustic wave generated by the irradiation of the subject with the light and converts the acoustic wave into an electrical signal, an analog-to-digital conversion unit that digitizes the electrical signal, a communication unit configured to wirelessly communicate the digitized electrical signal, and a synchronization control unit that controls time in which the light source emits the light and time in which the communication unit performs the wireless communication, wherein the synchronization control unit controls the light source and the communication unit such that the time in which the light source emits the light and the time in which the communication unit performs the wireless communication do not overlap with each other.

### BACKGROUND

### Field

The present disclosure relates to an ultrasonic probe and a photoacoustic apparatus including the same.

### Description of the Related Art

Photoacoustic apparatuses for imaging a shape or a function inside a subject body by using a photoacoustic effect have been studied heretofore. When such a conventional photoacoustic apparatus receives a user's instructions, a controller inside the photoacoustic apparatus transmits a signal to a driving circuit of a light source and the light source generates pulsed light. When the subject is irradiated with the pulsed light, photoacoustic waves are generated. The photoacoustic waves are received by a probe and converted into an electrical signal (photoacoustic signal). The controller performs signal processing, such as image reconstruction, on the photoacoustic signal and presents the resulting image to the user.

Japanese Patent Application Laid-Open No. 2016-49212 discusses a photoacoustic imaging apparatus in which an ultrasonic probe is connected to a main body housing via a communication cable.

In the photoacoustic imaging apparatus according to Japanese Patent Application Laid-Open No. 2016-49212, as the number of ultrasonic reception elements in the ultrasonic probe is increased to obtain higher image quality, the number of wires within the connecting cable grows larger, which increases the cable diameter and cable weight. Thus, the ultrasonic probe becomes less easy to handle.

Wireless communication techniques have been advancing in recent years with improvements in communication speed and miniaturization of communication devices. Japanese Unexamined Patent Application Publication No. 2002-530142 discusses a configuration in which an ultrasonic probe and an ultrasonic imaging system wirelessly communicate with each other

If the wireless communication technique used in the ultrasonic probe according to Japanese Unexamined Patent Application Publication No. 2002-530142 is employed to address the foregoing problem of Japanese Patent Application Laid-Open No. 2016-49212, an issue specific to photoacoustic apparatuses can occur. Specifically, the driving circuit of the light source for generating high-power pulsed light required in the photoacoustic apparatus needs to pass a large current in a short time. In that case, the driving circuit of the light source generates electromagnetic noise. The electromagnetic noise can interfere with the wirelessly-communicated signals to cause a communication error.

### SUMMARY

The present disclosure is directed to providing a photoacoustic apparatus in which an impact of electromagnetic noise from a light source is reduced in performing a photoacoustic measurement on wireless communication between an ultrasonic probe and a main body.

According to an aspect of the present disclosure, an ultrasonic probe includes a light source configured to irradiate a subject with emitted light, an acoustic wave reception unit configured to receive an acoustic wave generated by the irradiation of the subject with the light and convert the acoustic wave into an electrical signal, an analog-to-digital conversion unit configured to digitize the electrical signal, a communication unit configured to wirelessly communicate the digitized electrical signal, and a synchronization control unit configured to control time in which the light source emits the light and time in which the communication unit performs the wireless communication, wherein the synchronization control unit is configured to control the light source and the communication unit such that the time in which the light source emits the light and the time in which the communication unit performs the wireless communication do not overlap with each other.

Further features will become apparent from the following description of exemplary embodiments with reference to the attached drawings.

### BRIEF DESCRIPTION OF THE DRAWINGS

FIG. 1 is a block diagram for describing an ultrasonic probe according to a first exemplary embodiment.

FIG. 2 is an operation flowchart for describing the ultrasonic probe according to the first exemplary embodiment.

FIG. 3 is an operation flowchart for describing the ultrasonic probe according to the first exemplary embodiment.

FIG. 4 is a diagram, illustrating contents of a task memory, for describing the ultrasonic probe according to the first exemplary embodiment.

FIG. 5 is a chart illustrating operation timing for describing the ultrasonic probe according to the first exemplary embodiment.

FIG. 6 is a chart illustrating operation timing for describing an ultrasonic probe according to a second exemplary embodiment.

### DESCRIPTION OF THE EMBODIMENTS

An exemplary embodiment will be described below with reference to the drawings. Dimensions, materials, shapes, and relative arrangements of components described below shall be appropriately changed according to the configuration and various conditions of an apparatus to which an exemplary embodiment of is applied, and are not intended to limit the scope of the present disclosure to the following description.

A photoacoustic apparatus according to the present exemplary embodiment is configured to irradiate a subject with light (electromagnetic waves) and receive acoustic waves generated within the subject to obtain characteristic information inside the subject, using a photoacoustic effect. The characteristic information obtained here indicates a distribution of acoustic wave sources generated by the light irradiation, an initial sound pressure distribution inside the subject, or an optical energy absorption density distribution, an absorption coefficient distribution, or a concentration distribution of substance constituting the tissue, derived from the initial sound pressure distribution. The characteristic information typically is image data, but may be numerical and other information from which a state inside the subject can be recognized. Examples of the concentration distribution of the substance include an oxygen saturation distribution and an oxidized and reduced hemoglobin concentration distribution. Such characteristic information is also referred to as subject information. The photoacoustic apparatus according to the present disclosure can therefore be referred to as a subject information acquisition apparatus.

The acoustic waves as employed herein typically refer to ultrasonic waves, and can include elastic waves, which are called sound waves, ultrasonic waves, or acoustic waves. Acoustic waves generated from a photoacoustic effect can be referred to as photoacoustic waves or optical ultrasonic waves. A probe of the photoacoustic apparatus (subject information acquisition apparatus) receives acoustic waves generated inside the subject.

A first exemplary embodiment will be described below. The first exemplary embodiment controls time in which wireless communication between a probe unit (ultrasonic probe) and a main body unit (signal processing unit) of a photoacoustic apparatus is performed, and time in which a light source of the probe unit emits light.

### (Photoacoustic Apparatus)

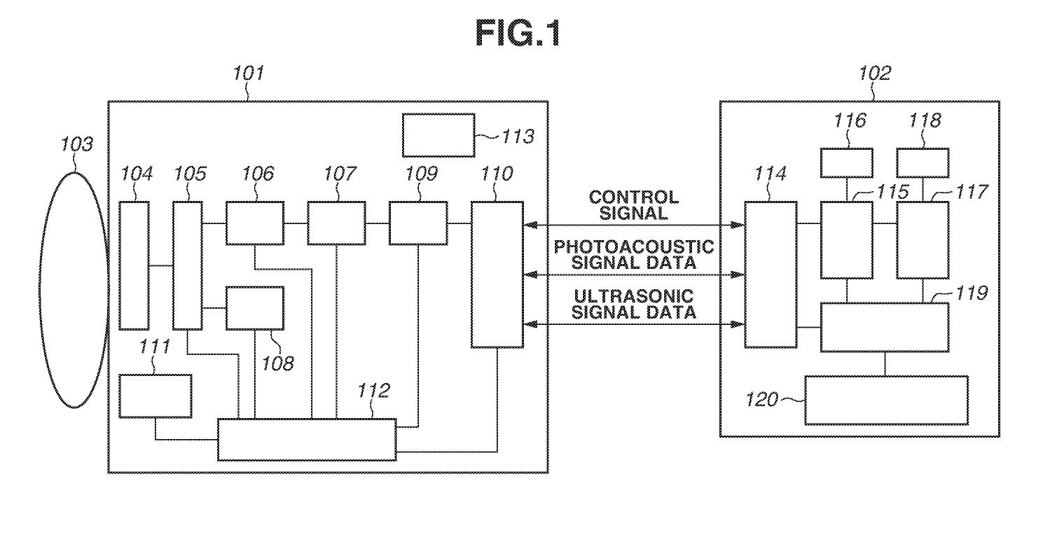

FIG. 1 is a block diagram illustrating the photoacoustic apparatus according to the present exemplary embodiment. The photoacoustic apparatus according to the present exemplary embodiment includes an ultrasonic probe 101 and a signal processing unit 102. In the present exemplary embodiment, the ultrasonic probe 101 is configured to obtain a photoacoustic signal deriving from a subject, and perform wireless data communication. The signal processing unit 102 is configured to receive data transmitted from the ultrasonic probe 101 and obtain information about the subject. Each component will be described in detail below.

### (Ultrasonic Probe)

In FIG. 1, the ultrasonic probe 101 irradiates a subject 103 with light, and receives and converts acoustic waves generated in the subject 103 into an electrical signal called a photoacoustic signal. The ultrasonic probe 101 according to the present exemplary embodiment also includes a function of transmitting ultrasonic waves to the subject 103, and receiving and converting ultrasonic waves reflected from tissue inside the subject 103 into an electrical signal called an ultrasonic signal. The ultrasonic probe 101 can also be referred to as a probe unit 101 of the photoacoustic apparatus. The light with which the subject 103 is irradiated is typically pulsed light.

The ultrasonic probe 101 and the signal processing unit 102 can perform wireless data communication (wireless communication) with each other. Signals generated by the probe unit 101 including the photoacoustic signal, the ultrasonic signal, and a control signal, can be digitized and transmitted to the signal processing unit 102. In the present exemplary embodiment, the digitized photoacoustic signal will be referred to as photoacoustic signal data. Similarly, the digitized ultrasonic signal will be referred to as ultrasonic signal data.

### (Signal Processing Unit (Main Body Unit))

In FIG. 1, the signal processing unit 102 can also be referred to as a main body unit of the photoacoustic apparatus. The signal processing unit 102 receives the photoacoustic signal data and ultrasonic signal data transmitted from the ultrasonic probe 101 via wireless data communication, and performs signal processing such as noise elimination. The signal processing unit 102 also performs image reconstruction processing on the resulting data to generate an image, and presents the obtained image to the user. In the present exemplary embodiment, the signal processing unit 102 includes a user interface (UI) 120 for inputting the user's instructions.

### (Subject)

The subject 103 is the target from which the photoacoustic apparatus obtains information. The subject 103 is, for example, a part of the body of an examinee. In the following description, a breast will be used as an example of the body part.

### (Acoustic Wave Reception Unit)

An acoustic wave reception unit 104 receives photoacoustic waves and ultrasonic waves from the subject 103, and converts the photoacoustic waves and the ultrasonic waves into photoacoustic signals and an ultrasonic signals, respectively. The acoustic wave reception units 104 according to the present exemplary embodiment can be configured to transmit ultrasonic waves.

In the present exemplary embodiment, 100 or more channels of acoustic wave reception units 104 are arranged in a one- or two-dimensional array within a surface where the ultrasonic probe 101 contacts the subject 103. The acoustic wave reception units 104 include acoustic elements. Examples of the acoustic elements include a piezo element and a capacitive transducer. In the present exemplary embodiment, ultrasonic waves can be transmitted out of the ultrasonic probe 101 by applying an electrical signal to the acoustic wave reception units 104.

When the acoustic wave reception units 104 receive photoacoustic waves or ultrasonic waves external from the ultrasonic probe 101, the acoustic wave reception units 104 output electrical signals. The acoustic wave reception units 104 can use the same elements, in part or all, in transmitting and receiving ultrasonic waves and in receiving photoacoustic waves. The acoustic wave reception units 104 can use different elements in transmitting and receiving ultrasonic waves, and in receiving photoacoustic waves.

### (Switching Circuit)

A switching circuit (transmission and reception switching unit) 105 switches between transmission and reception of ultrasonic waves. The switching circuit 105 includes an analog switch, a multiplexer, and a protection diode. The switching circuit 105 is connected to a synchronization control unit 112, and switches connections between acoustic wave reception units 104 and peripheral circuits correspondingly, in transmitting ultrasonic waves, in receiving ultrasonic waves, and in receiving photoacoustic waves, respectively. More specifically, in transmitting ultrasonic waves to the subject 103, a transmission control unit 108 and the acoustic wave reception units 104 are connected. In receiving ultrasonic waves reflected from the subject 103, an amplification unit 106 and the acoustic wave reception units 104 are connected. The amplification unit 106 and the acoustic wave reception units 104 are connected also in receiving photoacoustic waves from the subject 103.

If different elements are used during the transmission and reception of ultrasonic waves and during the reception of photoacoustic waves, the amplification unit 106 and the ultrasonic wave-receiving elements of the acoustic wave reception units 104 are connected in receiving ultrasonic waves. The amplification unit 106 and the photoacoustic wave-receiving elements of the acoustic wave reception units 104 are connected in receiving photoacoustic waves. The number of channels of the transmission control unit 108 can be less than that of the acoustic wave reception units 104 so that a plurality of elements shares circuitry.

### (Preamplifier Circuit)

The amplification unit 106 includes a preamplifier circuit for amplifying the photoacoustic signals and the ultrasonic signals output from the acoustic wave reception units 104. The preamplifier circuit includes a programmable gain amplifier and can dynamically change gain according to an externally generated setting. The preamplifier circuit is connected to the synchronization control unit 112. Based on instructions from the synchronization control unit 112, the preamplifier circuit can perform amplification processing at different amplification ratios (gains) between when amplifying the photoacoustic signals and when amplifying the ultrasonic signals. For example, the photoacoustic signals are typically weaker than the ultrasonic signals. The preamplifier circuit, therefore, provides a relatively large gain when the photoacoustic signals are received. The preamplifier circuit provides a relatively small gain when the ultrasonic signals are received. The preamplifier circuit can also perform time gain control (TGC) processing for increasing the gain to amplify weak signals from a deep part of the subject 103 as longer time elapses since the transmission of ultrasonic waves.

### (Analog-to-Digital Conversion Unit)

An analog-to-digital conversion unit (A/D conversion unit) 107 digitizes the amplified signals. In the present exemplary embodiment, the A/D conversion unit 107 includes an anti-aliasing filter for preventing generation of folding noise, an A/D conversion circuit, and a memory, which temporarily stores A/D-converted photoacoustic signal data and ultrasonic signal data. The A/D conversion unit 107 is connected to the synchronization control unit 112, and samples the photoacoustic signals in synchronization with a control signal of light irradiation sent to a light source 111. The A/D conversion unit 107 also samples the ultrasonic signals in synchronization with a control signal of ultrasonic wave transmission from the transmission control unit 108.

### (Transmission Control Unit)

The transmission control unit 108 generates pulse signals for driving the acoustic wave reception units 104. In the present exemplary embodiment, the transmission control unit 108 includes a high voltage pulsar circuit and a beam former circuit, which generates driving pulses of each acoustic wave reception unit 104. The transmission control unit 108 controls the phase of the signals to the respective acoustic wave reception units 104 to perform scanning and transmission aperture control of an ultrasonic beam, based on settings and a control signal of ultrasonic wave transmission from the synchronization control unit 112.

### (Data Processing Circuit)

A data processing circuit 109 performs data processing on the photoacoustic signal data and ultrasonic signal data digitized by the A/D conversion unit 107. The data processing circuit 109 includes a field programmable gate array (FPGA) or a microcontroller. The data processing circuit 109 is connected to the synchronization control unit 112, and converts the photoacoustic signal data and the ultrasonic signal data into a form suitable for communication with the main body unit 102. Specifically, the data processing circuit 109 performs data compression processing and noise elimination processing. Here, the data processing circuit 109 can apply different types of processing to the ultrasonic signal data and the photoacoustic signal data. For example, the data processing circuit 109 can apply filter processing of different passbands at the time of receiving the photoacoustic signals and at the time of receiving the ultrasonic signals, based on the frequencies of the respective signals. When receiving the photoacoustic signals, the data processing circuit 109 can integrate photoacoustic signal data corresponding to a plurality of times of light emission to reduce random noise. The data processing circuit 109 also converts the ultrasonic signal data into a predetermined format and adds additional information. The additional information includes an identifier (ID) of the probe unit 101 and information for distinguishing photoacoustic signal data from ultrasonic signal data. The additional information also includes information for distinguishing the types of the photoacoustic signal data and the ultrasonic signal data. For example, if photoacoustic signal data for a plurality of wavelengths of light is obtained during acquisition of the photoacoustic signals, the additional information includes information for identifying the wavelengths. If B-mode data and Doppler data are obtained during acquisition of the ultrasonic signal data, the additional information includes information for identifying B-mode and Doppler mode.

### (Communication Unit)

A communication unit (communication interface) 110 of the probe unit 101 wirelessly transmits the ultrasonic signal data and photoacoustic signal data obtained by the probe unit 101 to the main body unit 102, and transmits and receives control commands to/from the main body unit 102. The communication unit 110 according to the present exemplary embodiment is a wireless communication interface, however, an interface that performs wired communication can be included.

Usable communication protocols can include wireless communication protocols such as Wi-Fi®, Bluetooth®, and second generation (2G), third generation (3G), and fourth generation (4G) protocols. The communication interface 110 includes an input buffer, a communication module, and an antenna. The communication module includes a baseband unit and a radio frequency (RF) unit, and performs addition of header information, error correction, and packetization on data based on the wireless communication protocol. The communication module also performs spectral spreading, modulation, and demodulation processing according to the wireless communication protocol. The communication module also performs retransmission processing in the event of a communication error.

The input buffer is a buffer memory for temporarily storing the photoacoustic signal data and the ultrasonic signal data from the data processing circuit 109. The buffer memory is a first-in-first-out (FIFO) memory, into which data output from the data processing circuit 109 is sequentially input and from which the first input data is sequentially read into the wireless communication module. The buffer memory includes a dual-port memory. A data write from the data processing circuit 109 and a data read from the wireless communication module can be performed in parallel. The internal state of the buffer memory can be constantly monitored by the synchronization control unit 112.

The content of the control commands transmitted from the main body unit 102 to the probe unit 101 includes a start, a quit, and a pause of imaging, and a state notification. Parameters of a photoacoustic signal acquisition function, and parameters used at the time of acquiring ultrasonic signals are also included in the control commands. Examples of the parameters include information about whether the signal is acquired, an acquisition frequency, the type of wavelength of the light source 111, an ultrasonic operation mode, the type of transmission beam forming, and the data compression ratios of the respective signals.

In the present exemplary embodiment, it is desirable that the communication unit 110 can perform wired communication. The frame rate of the electrical signals during wireless communication can be made lower than that of the electrical signals during the wired communication.

The electrical signals to be wirelessly communicated can include a signal obtained by adding a plurality of electrical signals obtained in a certain period, or an arithmetically-averaged electrical signal obtained by adding and dividing a plurality of electrical signals by the number of electrical signals. Using such an added or arithmetically-averaged electrical signal enables reduction in the amount of wireless communication data.

The wireless communication can be performed at a timing between emissions if the light source 111 emits light a plurality of times.

### (Light Source)

The light source 111 irradiates the subject 103 with emitted light.

In the present exemplary embodiment, the light source 111 includes, for example, a semiconductor laser device and a driving circuit. The light source 111 includes an external trigger signal, and is configured such that its emission timing can be controlled by the synchronization control unit 112. The light source 111 also includes a light amount setting signal, and its light amount can be set by the synchronization control unit 112. If the set light amount is large, the driving circuit in the light source 111 increases a value of a current to be supplied to the semiconductor laser device. If the set light amount is small, the driving circuit reduces the value of the current to be supplied to the semiconductor laser device. The light source 111 can include a plurality of semiconductor laser devices with different oscillation wavelengths and emit light of different wavelengths based on the setting of the synchronization control unit 112.

The light source 111 can include a unit for accepting instructions for the light emission of the light source 111. A switch unit that determines the timing of light irradiation by the light source 111 can be provided on the probe unit 101.

The light source 111 can be configured to reduce the repetition frequency of the light emitted from the light source 111 when an amount of data of the wirelessly communicated electrical signals reaches or exceeds a predetermined value.

The light source 111 can include a plurality of semiconductor light-emitting elements arranged in an array. The light source 111 can include a solid-state laser such as a titanium-sapphire laser, a yttrium aluminum garnet (YAG) laser, or an alexandrite laser. Examples of the semiconductor light-emitting elements include a light-emitting diode (LED) and a semiconductor laser (LD).

### (Synchronization Control Unit)

The synchronization control unit 112 controls the time in which the light source 111 emits light and the time in which the communication unit 110 performs wireless communication. In addition to the light source 111 and the communication unit 110, the synchronization control unit 112 can communicate with various parts in the probe unit 101 for synchronization control. The synchronization control unit 112 includes a microcomputer and software.

In the present exemplary embodiment, the synchronization control unit 112 performs control to separate the timing of wireless communication from that of laser light emission. The synchronization control unit 112 controls the timing of light irradiation performed by the light source 111 and the timing of wireless communication performed by the communication unit 110. Specifically, the synchronization control unit 112 controls driving of the light source 111 and the communication unit 110 such that the time in which the light source 111 emits light and the time in which the communication unit 110 performs wireless communication do not overlap with each other.

Since the time in which the light source 111 emits light and the time in which the communication unit 110 performs wireless communication do not overlap with each other, the synchronization control unit 112 can suppress mixing of electromagnetic noise from the light source 111 into wireless communication data and reduce its impact on the wireless communication.

An example of the control that the synchronization control unit 112 performs is a method (first mode) for stopping driving the communication unit 110 so that wireless communication is not performed during the time in which the light source 111 emits light. Another example is a method (second mode) for stopping driving the light source 111 so that the light source 111 does not emit light during the time in which the communication unit 110 performs wireless communication. The synchronization control unit 112 can be configured to switch between the first and second modes. Details of the control method by the synchronization control unit 112 will be described below.

### (Power Supply Unit)

A battery 113 supplies power to various parts in the probe unit 101. A small-sized lithium ion battery can be used as the battery 113. The probe unit 101 includes terminals for charging the battery 113. The battery 113 can be charged by connecting the terminals to the main body unit 102. A charging cable can be used for the connection. Alternatively, the charging terminals of the probe unit 101 can be brought into contact with charging terminal portions of the main body unit 102. The microcomputer in the synchronization control unit 112 monitors the remaining level of the battery 113, and displays a warning if the remaining level is running low. An LED or a small-sized liquid crystal display unit can be provided on the probe unit 101 to display the remaining battery level or a warning. When the remaining battery level is running low, the microcomputer can notify the main body unit 102 of the battery state via the wireless interface 110 to display a warning on the UI 120 in the main body unit 102.

### (Communication Unit of Signal Processing Unit (Main Body Unit))

A communication interface 114 enables the main body unit 102 to wirelessly receive the ultrasonic signal data and photoacoustic signal data obtained by the probe unit 101, and transmits and receives control commands to/from the probe unit 101. The communication interface 114 on the main body side includes a wireless communication function similar to the communication interface 110 on the probe side. The received ultrasonic signal data and photoacoustic signal data are transmitted to a signal processing circuit 115.

The signal processing circuit (digital circuit) 115 applies signal processing to the ultrasonic signal data and the photoacoustic signal data. An FPGA or a digital signal processor (DSP) is implemented as the digital circuit 115. The signal processing circuit 115 distinguishes the types of ultrasonic signal data and photoacoustic signal data based on the information added by the data processing circuit 109, and applies different types of signal processing to each of them. For example, on B-mode data of the ultrasonic signals, the signal processing circuit 115 performs phasing addition, logarithmic amplification, envelope detection processing, and harmonic imaging processing. On Doppler data of the ultrasonic signals, the signal processing circuit 115 performs frequency analysis and high-pass filter (HPF) processing, and generates data indicating the speed of blood flow at an observation position. On the photoacoustic signal data, the signal processing circuit 115 performs response correction processing for the acoustic wave reception units 104, noise elimination processing, and band-pass filter processing. In such processing, the signal processing circuit 115 can change parameters of the signal processing based on probe ID information included in the additional information. For example, in the response correction processing for the acoustic wave reception units 104, the signal processing circuit 115 can identify the types of acoustic wave reception units 104 from the probe ID information, and select different impulse response waveforms. In the band-pass filter processing, the signal processing circuit 115 can identify the reception frequency band of the acoustic wave reception units 104 from the probe ID information, and select a corresponding filter. The signal processing circuit 115 also identifies, from the additional information, the wavelength of the light source 111 in obtaining photoacoustic signal data, and prevents photoacoustic signal data of different wavelengths from mixing there.

### (Storage Unit)

A storage unit (memory) 116 stores the ultrasonic signal data and photoacoustic signal data processed by the signal processing circuit 115. The signal processing circuit 115 stores each data into different areas according to its type.

An image processing circuit 117 reads the data stored in the memory 116 and performs imaging according to the type of the data. The image processing circuit 117 includes a processor dedicated to image processing (graphics processing unit (GPU)). With respect to the ultrasonic signal data, the image processing circuit 117 synthesizes B-mode data on each scan line to generate a B-mode image. With respect to the photoacoustic signal data, the image processing circuit 117 performs image reconstruction processing to generate an initial sound pressure distribution or absorption coefficient distribution image. As algorithms for the image reconstruction processing, universal back projection (UBP) and model-based reconstruction processing are known. The image processing circuit 117 also calculates an oxygen saturation distribution by using photoacoustic signal data of a plurality of wavelengths.

A memory 118 stores the data imaged by the image processing circuit 117. A hard disk drive (HDD) or a solid-state drive (SSD) is used as the memory 118.

A control unit (processor) 119 is connected to the components on the main body side and controls the entire main body unit 102. The control unit 119 includes a central processing unit (CPU) and software running thereon. The control unit 119 receives an imaging instruction and imaging parameters input by the user via the UI 120, and outputs commands to the probe unit 101 via the communication interface 114. The probe unit 101 acquires ultrasonic signal data and photoacoustic signal data based on the content of the commands received via the communication interface 110, and transmits the obtained data to the main body unit 102 via the communication interface 110. The main body unit 102 receives the ultrasonic signal data and the photoacoustic signal data via the communication interface 114, and generates diagnostic images by using the signal processing circuit 115 and the image processing circuit 117. The diagnostic images are output to the UI 120 via the control unit 119 and presented to the user.

The UI 120 accepts an instruction input to the photoacoustic apparatus from the user, and output diagnostic images to the user. Specifically, the UI 120 includes a keyboard, a mouse, and a display.

### (Operation Flow of Signal Processing Unit)

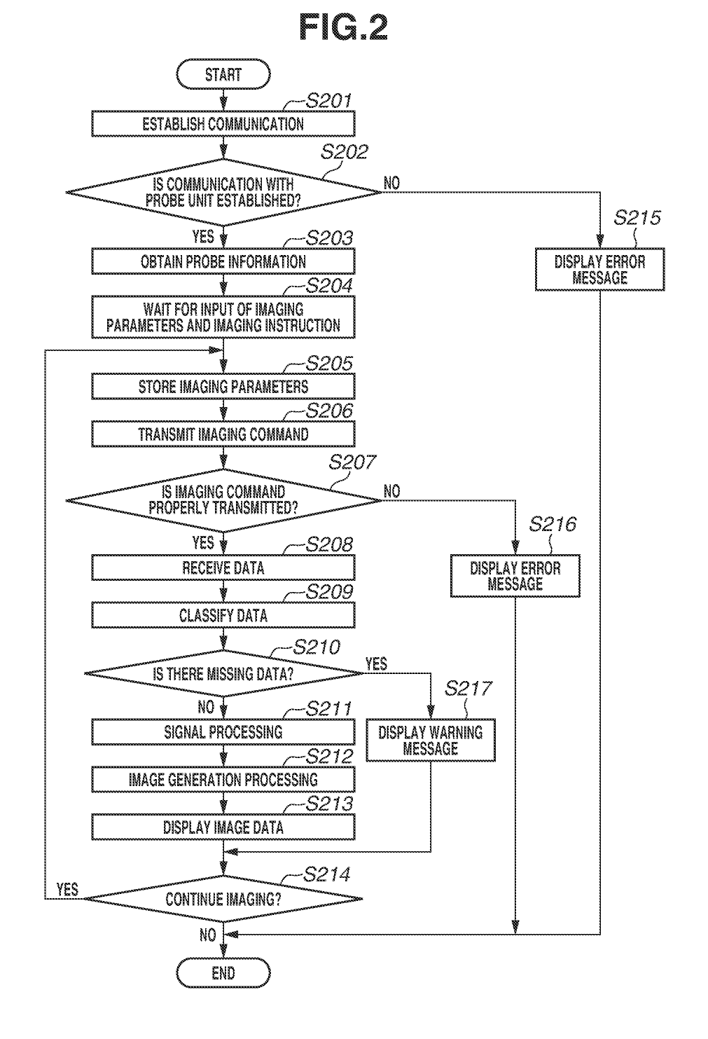

Next, an operation flow to be performed in the main body unit 102 will be described. FIG. 2 is a flowchart illustrating an operation of the components in the main body unit 102.

### (Step S201)

In step S201, the control unit 119 transmits instructions to the communication interface 114 to transmit a communication command. The control unit 119 searches for a probe with a probe ID registered by the user, and if there is a response, determines that communication is established. If there are responses from a plurality of probes, the control unit 119 displays a list of communicable probes on the UI 120 for user selection.

### (Step S202)

In step S202, the control unit 119 determines whether communication with the probe unit 101 is established. If the communication is not established (NO in step S202), the control unit 119 determines that there is no nearby usable probe or the battery 113 is dead, and the processing proceeds to step S215. If the communication with the probe unit 101 is established (YES in step S202), the processing proceeds to step S203.

### (Step S203)

In step S203, the control unit 119 requests probe information from the probe unit 101. Specifically, the control unit 119 obtains information such as wavelength of the light source 111, a maximum possible frequency of light emission, the number of elements of the acoustic wave reception units 104, bandwidth, center frequency, the number of bits of the A/D conversion unit 107, a remaining level of the battery 113, and a communication speed of the communication interface 110. The obtained information is stored in an internal memory of the control unit 119.

### (Step S204)

In step S204, the control unit 119 waits until the user inputs imaging parameters and an imaging instruction via the UI 120. If the input is completed, the processing proceeds to step S205.

### (Step S205)

In step S205, the control unit 119 stores the imaging parameters within its internal memory. The imaging parameters include a type of diagnostic image to be obtained, a depth of an imaging object, an imaging range of ultrasonic waves, a repetition frequency of ultrasonic waves, the presence or absence of a function of a Doppler-based blood flow measurement, an irradiation period of pulsed light, the number of times of irradiation, and a wavelength.

### (Step S206)

In step S206, the control unit 119 transmits instructions to the communication interface 114 to transmit an imaging command to the probe unit 101. The imaging command includes parameters needed for the acquisition of ultrasonic signals and photoacoustic signals. Specifically, the parameters needed for the acquisition of ultrasonic signals include the number of ultrasonic beams, a repetition frequency, a beam scanning method, a focus point, and a type of TGC gain table. The parameters needed for the acquisition of photoacoustic signals include the repetition frequency of the light source 111, the number of times of light irradiation, a light irradiation intensity, the type of wavelength, a gain at the time of reception, and the cumulated number of times of signal reception. Temporal parameters for the acquisition of ultrasonic signals and photoacoustic signals are also included in the parameters. For example, such parameters are information about whether to alternately perform the acquisition of ultrasonic signals and photoacoustic signals or perform Alternatively, the acquisition of photoacoustic signals are acquired M times in succession after ultrasonic signals are acquired N times in succession. The control unit 119 determines such information needed for the acquisition of ultrasonic signals and photoacoustic signals, from the imaging parameters instructed by the user, and generates and transmits the imaging command to the probe unit 101.

### (Step S207)

In step S207, the control unit 119 determines whether the imaging command is properly transmitted. If the communication interface 114 successfully receives from the probe unit 101 a confirmation responding to the transmission of the imaging command in step S206, the control unit 119 determines that the imaging command is properly transmitted (YES in step S207), and the processing proceeds to step S208. If the confirmation response is not successfully received, the control unit 119 retransmits the imaging command several times. If the confirmation response is not received even after retransmission is carried out several times (NO in step S207), the processing proceeds to step S216.

### (Step S208)

In step S208, the communication interface 114 receives ultrasonic signal data and photoacoustic signal data transmitted from the probe unit 101. The received data is stored in the FIFO memory in the communication interface 114 and sequentially read out by the signal processing circuit 115.

### (Step S209)

In step S209, the communication interface 114 classifies and rearranges types of received data based on header information about the data. If some of the packets of data are retransmitted during wireless communication, the sequential order of the data may be altered. In that case, the data is rearranged to restore the original order based on sequence numbers recorded in the header information. Such processing is performed within the communication interface 114 according to the Transmission Control Protocol/Internet Protocol (TCP/IP). The data types of the rearranged ultrasonic signal data and photoacoustic signal data are identified based on the additional information, and the pieces of data are stored within the memory 116.

### (Step S210)

In step S210, the signal processing circuit 115 checks whether there is missing data. In the case of the ultrasonic signals, the signal processing circuit 115 checks whether there is a complete set of ultrasonic signal data corresponding to a single ultrasonic transmission beam. In the case of the photoacoustic signals, the signal processing circuit 115 checks whether there is a complete set of photoacoustic signal data corresponding to single pulsed light irradiation. If there is a complete set of data (NO in step S210), the processing proceeds to step S211. If some data is still missing after a certain time of waiting (YES in step S210), the processing proceeds to step S217.

### (Step S211)

In step S211, the signal processing circuit 115 performs signal processing on the ultrasonic signal data and the photoacoustic signal data based on the data types, and stores the result in the memory 116.

### (Step S212)

In step S212, the image generation unit 117 reads the data from the memory 116, performs image generation processing based on the data types, and stores the result in the memory 118.

### (Step S213)

In step S213, the control unit 119 sequentially reads and displays the image data stored in the memory 118 on the display of the UI 120.

### (Step S214)

In step S214, the control unit 119 determines whether to continue the imaging based on instructions from the user. If the imaging is to be continued (YES in step S214), the processing proceeds to step S205. If the user issues an imaging end instruction via the UI 120, the control unit 119 determines not to continue the imaging (NO in step S214), and the processing ends. If the user changes the imaging parameters via the UI 120, the control unit 119 determines to continue the imaging (YES in step S214), and the processing proceeds to step S205. In step S205, the control unit 119 obtains the changed imaging parameters, and continues the processing. If the user does not make any particular instruction, the control unit 119 determines to continue the imaging (YES in step S214), and the processing proceeds to step S205. In step S205, the control unit 119 continues the processing by using the same imaging parameters as before.

### (Step S215)

In step S215, the control unit 119 displays an error message that the communication with the probe unit 101 cannot be established on the display of the UI 120, and the processing ends.

### (Step S216)

In step S216, the control unit 119 displays an error message that the imaging command cannot be communicated on the display of the UI 120, and the processing ends.

### (Step S217)

In step S217, the control unit 119 displays a warning message that reception data is missing on the display of the UI 120 and the control unit 119 proceeds to step S214 to continue the processing. The warning message can be turned off by a setting made by the user to continue the processing even with part of the images missing. In such a case, the control unit 119 interpolates the missing data, and the processing proceeds to step S211.

### (Operation Flow of Ultrasonic Probe)

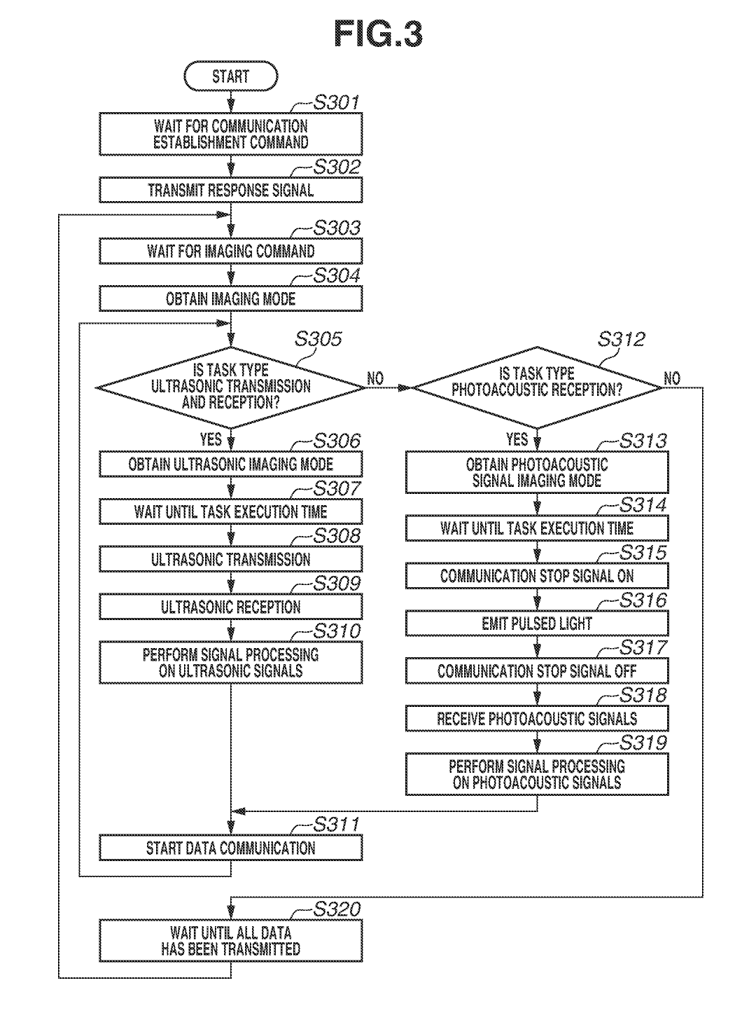

Next, an operation flow to be followed by the probe unit 101 will be described. FIG. 3 is a flowchart illustrating an operation of the components of the probe unit 101.

### (Step S301)

After power-on, in step S301, the probe unit 101 enters a waiting state for a communication establishment command from the main body unit 102. If the communication establish command is received from the main body unit 102 via the communication interface 110, the processing proceeds to step S302. During the waiting state, the probe unit 101 can bring the modules other than the communication interface 110 into a sleep state to reduce consumption of the battery 113. When the communication interface 110 receives the communication establish command, the communication interface 110 switches the synchronization control unit 112 from the sleep state to a normal state.

### (Step S302)

In step S302, the synchronization control unit 112 transmits a response signal to the main body unit 102 via the communication interface 110, and pairs the probe unit 101 with the main body unit 102. In addition, the synchronization control unit 112 transmits information specific to the probe unit 101, such as the probe ID and supported communication standards, to the main body unit 102.

The information specific to the probe unit 101 includes information about the light source 111, information about the acoustic wave reception units 104, and other information about the probe unit 101. Examples of the information about the light source 111 include a type of wavelength of the light source 111, a maximum possible frequency of light emission, life of the light source 111, and a light amount of the light source 111. Examples of the information about the acoustic wave reception units 104 include the number of elements, a bandwidth, and a center frequency of the acoustic wave reception units 104. Examples of the other information about the probe unit 101 include information such as the number of bits of the A/D conversion unit 107, a remaining level of the battery 113, and a communication speed of the communication interface 110.

### (Step S303)

In step S303, the probe unit 101 enters a waiting state for an imaging command from the main body unit 102. If the imaging command is received from the main body unit 102 via the communication interface 110, the processing proceeds to step S304. During the waiting state, the modules other than the communication interface 110 can enter the sleep state to reduce the consumption of the battery 113. In that case, the communication interface 110 switches the synchronization control unit 112 from the sleep state to the normal state upon receiving the imaging command.

### (Step S304)

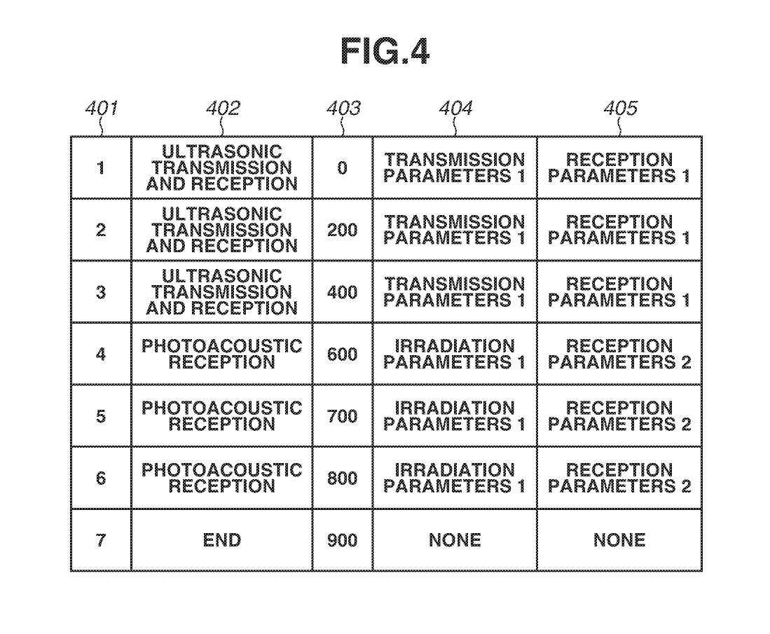

In step S304, the synchronization control unit 112 analyzes received packets of the imaging command, determines order, the numbers of times, and time intervals between transmitted and received ultrasonic waves and received photoacoustic waves to perform task scheduling. A series of tasks is stored in a task memory in the synchronization control unit 112. As an example, FIG. 4 illustrates the contents of the task memory when the transmission and reception of ultrasonic waves is performed three times at intervals of 200 μs, and then the reception of photoacoustic signals is performed three times at intervals of 100 μs. Each task includes an ID number 401. In the present exemplary embodiment, there are three task types 402, including transmission and reception of ultrasonic waves, reception of photoacoustic waves, and end. A time area 403 stores a task execution time expressed in units of microseconds. An area 404 stores parameters specific to transmission of ultrasonic waves during ultrasonic transmission and reception, and parameters specific to light irradiation during photoacoustic reception. The numbers of the transmission parameters are stored here, and other areas are referred to for details of the individual parameters. An area 405 stores parameters specific to reception of ultrasonic waves during ultrasonic transmission and reception, and stores parameters of reception of photoacoustic signals during photoacoustic reception. The numbers of the reception parameters are stored here, and other areas are referred to for details of the individual parameters. This advantageously enables a flexible response if the types of parameters increase.

### (Step S305)

In step S305, the synchronization control unit 112 reads the top task of the task memory, and determines whether the task type 402 is ultrasonic transmission and reception. If the task type 402 is ultrasonic transmission and reception (YES in step S305), the processing proceeds to step S306. If the task type 402 is not ultrasonic transmission and reception (NO in step S305), the processing proceeds to step S312.

### (Step S306)

In step S306, the synchronization control unit 112 reads the transmission parameter area 404 of the task memory, and sets an operation of the transmission control unit 108. The synchronization control unit 112 also reads the reception parameter area 405, and sets an operation of the amplification unit 106, the A/D conversion unit 107, and the data processing circuit 109. Transmission parameters relate to the formation of an ultrasonic beam to be transmitted to the subject 103. The transmission parameters include information such as the numbers of the acoustic wave reception units 104 to be driven, driving voltages and driving time widths of the acoustic wave reception units 104, and driving time differences between the acoustic wave reception units 104. Reception parameters relate to ultrasonic signals received from the subject 103. The reception parameters include information such as the gain of the amplification unit 106, the TGC table, and a sampling frequency of the A/D conversion unit 107. If the data processing circuit 109 performs phasing addition, noise elimination, and/or data compression, information such as presence or absence of multi-stage focusing during reception, a type of digital filter, and a data compression ratio is included in the parameters.

### (Step S307)

In step S307, the synchronization control unit 112 reads the time area 403 of the task memory, and waits until the task execution time. If the task execution time comes, the processing proceeds to step S308. In the present exemplary embodiment, the execution time of the first task is 0 μm, and thus the processing proceeds to step S308.

### (Step S308)

In step S308, the synchronization control unit 112 issues instructions to the transmission and reception switching unit 105 to connect the transmission control unit 108 and the acoustic wave reception units 104. The synchronization control unit 112 then issues instructions to the transmission control unit 108 to start ultrasonic transmission to the subject 103. The transmission control unit 108 drives the acoustic wave reception units 104 to generate ultrasonic pulses based on the transmission parameters set in step S306. After the generation of the ultrasonic pulses, the processing proceeds to step S309. Part of the ultrasonic waves transmitted to the subject 103 are reflected in the tissue inside the subject 103 and converted into ultrasonic signals by the acoustic wave reception units 104.

### (Step S309)

In step S309, the synchronization control unit 112 issues instructions to the transmission and reception switching unit 105 to connect the amplification unit 106 and the acoustic wave reception units 104. The synchronization control unit 112 then issues instructions to the amplification unit 106 and the A/D conversion unit 107 to start ultrasonic reception from the subject 103. The amplification unit 106 and the A/D conversion unit 107 perform amplification and A/D conversion of the ultrasonic signals, respectively, based on the reception parameters set in step S306. After the processing, the data is stored in the memory of the data processing circuit 109.

### (Step S310)

In step S310, the synchronization control unit 112 issues instructions to the data processing circuit 109 to perform signal processing on the ultrasonic signals. Specifically, signal processing depending on the characteristics of the acoustic wave reception units 104, data integration, compression processing, and adding of additional information for data identification are performed. The processed data is stored in a memory in the communication interface 110.

### (Step S311)

In step S311, the synchronization control unit 112 issues instructions to the communication interface 110 to start data communication, and the processing returns to step S305. When the processing returns to step S305, the synchronization control unit 112 deletes the top task in the task memory. In step S305, the synchronization control unit 112 executes the next task. The communication interface 110 packetizes the data stored in the memory and starts its transmission to the main body unit 102. Here, if the communication stop signal is on, the communication interface 110 suspends communication. The communication interface 110 resumes communication when the communication stop signal is turned OFF.

### (Step S312)

In step S312, the synchronization control unit 112 reads the top task of the task memory, and determines whether the task type 402 is photoacoustic reception. If the task type 402 is photoacoustic reception (YES in step S312), the processing proceeds to step S313. If the task type 402 is not photoacoustic reception, i.e., an end (NO in step S312), the synchronization control unit 112 determines that all imaging operations instructed by the main body unit 102 have been completed, and the processing proceeds to step S320.

### (Step S313)

In step S313, the synchronization control unit 112 reads the irradiation parameter area 404 of the task memory, and sets an operation of the light source 111. The synchronization control unit 112 also reads the reception parameter area 405, and sets an operation of the amplification unit 106, the A/D conversion unit 107, and the data processing circuit 109. Irradiation parameters relate to the pulsed light with which the subject 103 is irradiated, and include information such as the driving power, wavelength, and pulse width of the semiconductor laser device. Reception parameters relate to photoacoustic signals received from the subject 103, and include information such as the gain of the amplification unit 106, the TGC table, and the sampling frequency of the A/D conversion unit 107. If the data processing circuit 109 performs noise elimination processing and/or data compression on the data, the reception parameters include information such as the type of digital filter and the compression ratio.

### (Step S314)

In step S314, the synchronization control unit 112 reads the time area 403 of the task memory, and waits until the task execution time. When the task execution time comes, the processing proceeds to step S315. In the present exemplary embodiment, the task execution time of the first task for photoacoustic reception is 1100 μs. The processing thus proceeds to step S315 at time 1100 μm.

### (Step S315)

In step S315, the synchronization control unit 112 transmits instructions to the communication interface 110 to turn the communication stop signal ON. The communication interface 110 in response suspends the data communication directed to the main body unit 102. If the suspension of the data communication is completed, the processing proceeds to step S316.

### (Step S316)

In step S316, the synchronization control unit 112 issues instructions to the transmission and reception switching unit 105 to connect the amplification unit 106 and the acoustic wave reception units 104. The synchronization control unit 112 then issues instructions to the light source 111 to start light irradiation of the subject 103. The light source 111 drives the semiconductor laser device to emit pulsed light having a time width of approximately 10 ns to 200 ns based on the irradiation parameters set in step S313. After the irradiation with the pulsed light, the processing proceeds to step S317. Part of the pulsed light with which the subject 103 is irradiated is absorbed by the tissue inside the subject 103, and photoacoustic waves are generated. The photoacoustic waves are converted into photoacoustic signals by the acoustic wave reception units 104.

### (Step S317)

In step S317, the synchronization control unit 112 transmits instructions to the communication interface 110 to turn the communication stop signal OFF. The communication interface 110 in response resumes the data communication with the main body unit 102. When the resumption of the data communication is completed, the processing proceeds to step S318.

### (Step S318)

In step S318, the synchronization control unit 112 performs reception of the photoacoustic signals.

### (Step S319)

In step S319, the synchronization control unit 112 issues instructions to the data processing circuit 109 to perform signal processing on the photoacoustic signals. Specifically, signal processing depending on the characteristics of the acoustic wave reception units 104, noise elimination processing, compression processing, and the addition of additional information for data identification are performed. The processed data is stored in the memory in the communication interface 110. The processing proceeds to step S311. In step S311, the synchronization control unit 112 transmits the photoacoustic signals to the main body unit 102.

### (Step S320)

In step S320, the synchronization control unit 112 waits until all the data has been transmitted to the main body unit 102. Whether all the data has been transmitted to the main body unit 102 is determined by monitoring the state of the communication interface 110. If all the data has been transmitted to the main body unit 102, the processing proceeds to step S303.

Since the time need for the irradiation with the pulsed light in step S316 is as short as 10 ns to 200 ns, the period for which the communication is stopped is 2 μs or less, even with overheads included. The impact on the communication between the probe unit 101 and the main body unit 102 is therefore small.

### (Time Chart)

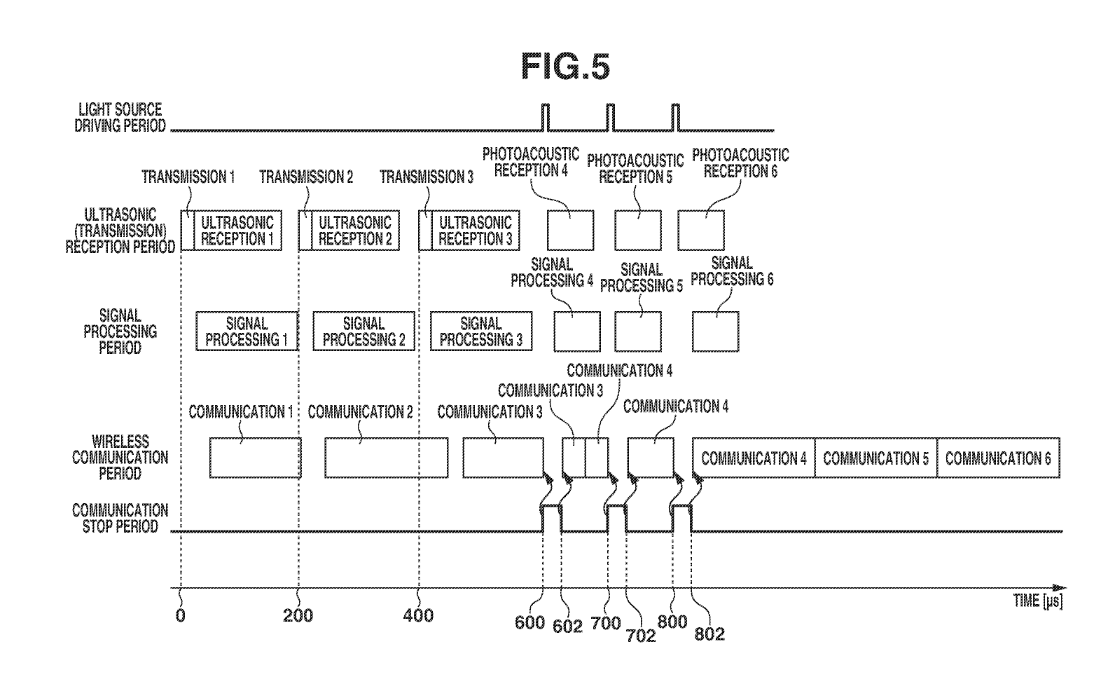

FIG. 5 illustrates an example of a time chart in a case where ultrasonic transmission and reception and photoacoustic reception are each performed three times. The top illustration in FIG. 5 illustrates the timing (light source driving period) of a signal (pulsed light driving signal) that causes the light source 111 to emit pulsed light. The second illustration from the top illustrates the reception timing (ultrasonic (transmission) reception period) of ultrasonic waves and photoacoustic waves by the acoustic wave reception units 104. The third illustration from the top illustrates the timing (signal processing period) in which the data processing circuit 109 performs signal processing. The fourth illustration from the top illustrates the timing (wireless communication period) in which the communication unit 110 communicates ultrasonic signal data and photoacoustic signal data to the main body unit 102. The fifth illustration from the top illustrates the timing of a communication control signal of the communication unit 110, which the synchronization control unit 112 controls. In the present exemplary embodiment, the fifth illustration illustrates the timing (communication stop period) of the communication stop signal for stopping the wireless communication of the communication unit 110. The horizontal axis of FIG. 5 indicates time. Transmission 1 corresponds to the transmission of ultrasonic waves of task number 1 in FIG. 4. Ultrasonic reception 1 corresponds to the reception of ultrasonic waves of task number 1. The numbers of transmissions 2 and 3, ultrasonic receptions 2 and 3, photoacoustic receptions 4 to 6, signal processing 1 to 6, and communications 1 to 6 in FIG. 5 also correspond to the task numbers of FIG. 4. At time 600 μs in FIG. 5, the synchronization control unit 112 raises the communication stop signal in response to a rise of the pulsed light driving signal. The communication interface 110 in response thereto suspends the data transmission of communication 3. After a fall of the pulsed light driving signal, the synchronization control unit 112 lowers the transmission stop signal at time 602 μs. The communication interface 110 in response thereto resumes the data transmission of communication 3. The same applies to times 700 μs to 702 μs and times 800 μs to 802 μs. In such a manner, the emission of the pulsed light by the light source 111 and the communication of the communication interface 110 can be controlled not to overlap with each other.

In a case where, for example, the sound speed inside the subject 103 is 1500 m/s, and the observation depth of the subject 103 is 100 mm, it takes approximately 134 μs of time to transmit and receive ultrasonic waves, and 67 μs to receive photoacoustic waves. As for the signal processing, the data can be successively processed after A/D conversion. The processing time is approximately the same as the reception time, and does not vary so much. By contrast, the communication with the main body unit 102 varies greatly depending on the condition of the location where the photoacoustic apparatus is placed at that time and the communication condition of surrounding devices. For example, a communication error or retransmission tends to occur with a considerable drop in communication speed in cases such as when the main body unit 102 and the probe unit 101 are widely separated, when there are obstacles blocking radio waves around, or there is electromagnetic interference with surrounding devices. The time needed for communication therefore changes dynamically, and a next task may need to be started during communication of previous data. For example, in FIG. 5, communication 2 takes a longer time than communication 1 does, and transmission 3 is started before the end of communication 2. For such a reason, the communication interface 110 includes a buffer memory of sufficient capacity.

In another example, suppose that the number of elements of the acoustic wave reception units 104 is 128 channels, the number of bits of the A/D conversion unit 107 is 12 bits, and the sampling frequency of the A/D conversion unit 107 is 40 MHz. In such a case, the amount of raw data of ultrasonic signals per ultrasonic transmission beam is approximately 8.3 Mbits. The amount of raw data of photoacoustic signals per photoacoustic reception is approximately 4.1 Mbits. With respect to the ultrasonic signals, the data processing circuit 109 can perform phasing addition of the 128 ch 12-bit data into a piece of 19-bit data, whereby the amount of data per ultrasonic transmission beam can be compressed to 0.101 Mbits. If communication 1 has an effective speed of 500 Mbps, communication 1 takes 202 μs of time. If communication 2 has an effective speed of 300 Mbps, communication 2 takes 336 μs. If communications 3 and later have an effective speed of 500 Mbps, communication 3 takes 202 μs, and communications 4, 5, and 6 take 8.2 ms each.

In such a manner, by stopping the wireless communication of the communication unit 110 during the light source driving period, the synchronization control unit 112 can suppress mixing of electromagnetic noise from the light source 111 into wireless communication data and reduce the impact on the wireless communication.

A second exemplary embodiment will be described below. In the foregoing first exemplary embodiment, a method for performing control to stop driving the communication unit 110 so that wireless communication is not performed during the time in which the light source 111 emits light, has been described. In the second exemplary embodiment, a method for performing control to stop driving a light source so that the light source does not emit light during the time in which a communication unit performs wireless communication, will be described. In the first and second exemplary embodiments, the apparatus configuration is the same.

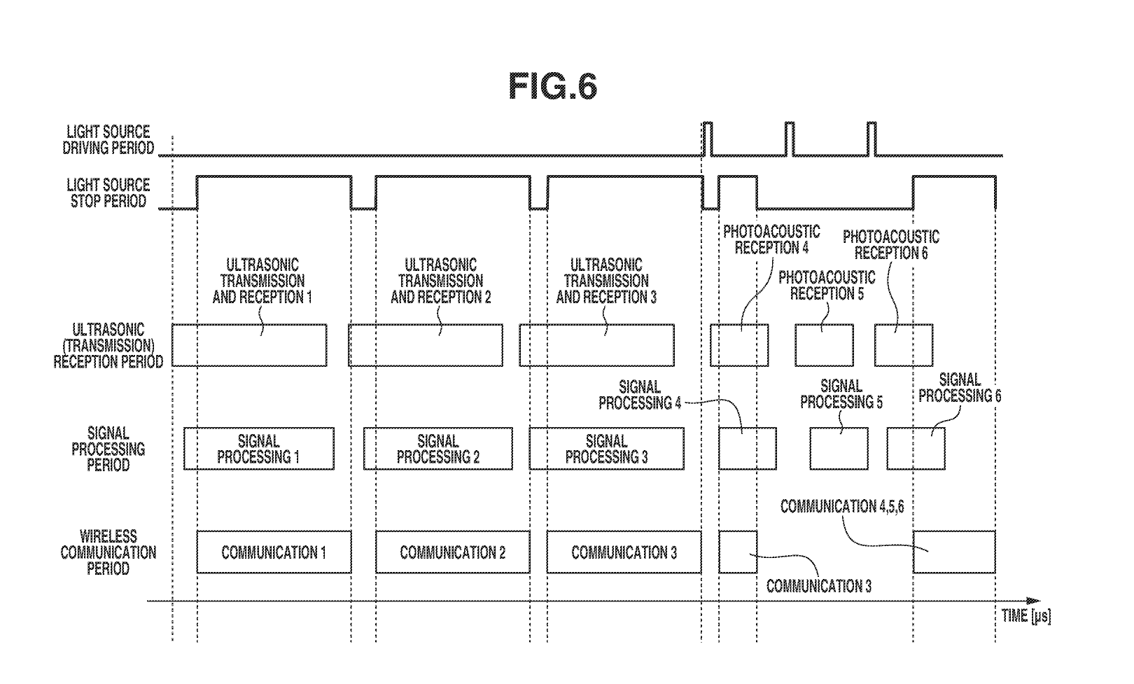

In FIG. 6, the second illustration from the top illustrates the timing of light emission of the light source 111, which is controlled by the synchronization control unit 112. Specifically, the illustration illustrates the timing (light emission stop period) of a light emission stop signal for stopping the light emission of the light source 111. In the present exemplary embodiment, as illustrated in FIG. 6, the wireless communication period is controlled such that the light source stop signal is generated to stop the light emission of the light source 111.

As described above, the synchronization control unit 112 can suppress mixing of electromagnetic noise from the light source 111 into wireless communication data and reduce the impact on the wireless communication by stopping the light emission of the light source 111 during the wireless communication period.

According to an ultrasonic probe according to an exemplary embodiment, mixing of electromagnetic noise from a light source into communication between a probe and a main body can be suppressed in performing photoacoustic measurement.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-165128, filed Aug. 30, 2017, which is hereby incorporated by reference herein in its entirety.

What is claimed is:

1. An ultrasonic probe comprising:
a light source configured to irradiate a subject with emitted light;
an acoustic wave reception unit configured to receive an acoustic wave generated by irradiation of the subject with the light and to convert the acoustic wave into an electrical signal;
an analog-to-digital conversion unit configured to digitize the electrical signal;
a communication unit configured to wirelessly communicate the digitized electrical signal; and
a synchronization control unit configured to control time in which the light source emits the light and time in which the communication unit performs the wireless communication,
wherein the synchronization control unit is configured to control the light source and the communication unit such that the time in which the light source emits the light and the time in which the communication unit performs the wireless communication do not overlap with each other.

2. The ultrasonic probe according to claim 1, wherein the synchronization control unit is configured to perform control to stop driving the communication unit so that the wireless communication is not performed during the time in which the light source emits the light.

3. The ultrasonic probe according to claim 1, wherein the synchronization control unit is configured to perform control to stop driving the light source so that the light source does not emit the light during the time in which the communication unit performs the wireless communication.

4. The ultrasonic probe according to claim 1, wherein the acoustic wave reception unit is configured to transmit an ultrasonic wave.

5. The ultrasonic probe according to claim 1, wherein the ultrasonic probe is configured to communicate the electrical signal or the digitized electrical signal via wired communication.

6. The ultrasonic probe according to claim 5, wherein a frame rate of the electrical signal in performing the wireless communication is lower than that of the electrical signal in performing the wired communication.

7. The ultrasonic probe according to claim 1, further comprising an acceptance unit configured to accept an instruction for the light emission of the light source.

8. The ultrasonic probe according to claim 1, wherein the synchronization control unit is configured to switch between a first mode in which control is performed to stop driving the communication unit so that the wireless communication is not performed during the time in which the light source emits the light and a second mode in which control is performed to stop driving the light source so that the light source does not emit the light during the time in which the communication unit performs the wireless communication.

9. The ultrasonic probe according to claim 1,
wherein the light source is configured to emit pulsed light, and
wherein the synchronization control unit is configured to perform control to reduce a repetition frequency of the pulsed light when a data amount of the wirelessly communicated digitized electrical signal is greater than or equal to a predetermined value.

10. The ultrasonic probe according to claim 1, wherein the wirelessly communicated digitized electrical signal is a signal obtained by adding a plurality of electrical signals obtained by the acoustic wave reception unit in a certain period.

11. The ultrasonic probe according to claim 1, wherein the light source includes a plurality of semiconductor light-emitting elements arranged in an array.

12. The ultrasonic probe according to claim 1, wherein the communication unit is configured to, if the light source performs the irradiation with the light a plurality of times, perform the wireless communication between irradiations.

13. A photoacoustic apparatus comprising:
a light source configured to irradiate a subject with emitted light;
an acoustic wave reception unit configured to receive an acoustic wave generated by irradiation of the subject with the light and to convert the acoustic wave into an electrical signal;
an analog-to-digital conversion unit configured to digitize the electrical signal;
a communication unit configured to wirelessly communicate the digitized electrical signal; and
a synchronization control unit configured to control time in which the light source emits the light and time in which the communication unit performs the wireless communication; and
a signal processing unit configured to obtain information about the subject based on at least the wirelessly communicated digitized electrical signal,
wherein the synchronization control unit is configured to control the light source and the communication unit such that the time in which the light source emits the light and the time in which the communication unit performs the wireless communication do not overlap with each other.
